(19) United States
(12) Patent Application Publication
(10) Pub. No.: US 2025/0386816 A1
(43) Pub. Date: Dec. 25, 2025

(54) SPOOL FOR A DUAL-BEARING REEL AND DUAL-BEARING REEL

(71) Applicant: Shimano Inc., Osaka (JP)

(72) Inventors: Youhei TOAKE, Osaka (JP); Kunio TAKECHI, Osaka (JP)

(21) Appl. No.: 19/226,832

(22) Filed: Jun. 3, 2025

(30) Foreign Application Priority Data
Jun. 19, 2024 (JP) 2024-098892

(51) Int. Cl. A01K 89/015; A01K 89/00; B65H 75/02

(52) U.S. Cl. CPC A01K 89/01931; A01K 89/003; B65H 75/02

(57) ABSTRACT

A spool for a dual-bearing reel, includes a bobbin trunk having an outer circumferential surface around which a fishing line is capable of being wound, and a through-hole extending through the outer circumferential surface in a radial direction of a rotational axis of the spool, a pillar portion extending from an inner circumferential surface of the bobbin trunk toward the rotational axis, and being disposed at a position that does not overlap with the through-hole as viewed from the radial direction, and first and second flanges extending from first and second ends of the bobbin trunk, respectively, in a direction away from the rotational axis, the outer circumferential surface of the bobbin trunk having a tapered surface inclined in a direction approaching the rotational axis toward the first and second flanges.

### CROSS-REFERENCE TO RELATED APPLICATIONS

This application claims priority to Japanese Patent Application No. 2024-098892, filed on Jun. 19 2024. The entire disclosure of Japanese Patent Application No. 2024-098892 is hereby incorporated by reference.

### BACKGROUND

### Technical Field

The present disclosure relates to a spool for a dual-bearing reel, and a dual-bearing reel.

### Background Information

The spool for a dual-bearing reel generally comprises a bobbin trunk and a pair of flanges. A fishing line is wound around the outer circumferential surface of the bobbin trunk. The pair of flanges are disposed at two ends of the bobbin trunk. The outer circumferential surface of the bobbin trunk of the spool disclosed in Japanese Laid Open Patent Application No. 2020-127378 is slightly inclined with respect to the rotational axis of the spool so as to increase in diameter toward the pair of flanges.

### SUMMARY

In a dual-bearing reel, it has been determined that the sensation of rotation during casting is improved by improving the static balance of the spool in a state in which the fishing line is wound around the spool. In order to improve the static balance of the spool, the first layer of fishing line that is initially wound around the bobbin trunk preferably does not shift when the second layer of fishing line is wound around the bobbin trunk. It has been found that in a conventional spool for a dual-bearing reel, there is the risk that the first layer of fishing line will shift when the second layer of fishing line is wound around the bobbin trunk. Accordingly, spools for dual-bearing reels and dual bearing reels can be improved.

An object of the present disclosure is to provide a spool and a dual-bearing reel that improves the sensation of rotation during casting.

With regards to a first aspect of the present disclosure, a spool for a dual-bearing reel comprises a bobbin trunk, a pillar portion, and a pair of flanges. The bobbin trunk has an outer circumferential surface around which a fishing line is wound, and at least one through-hole that penetrates the outer circumferential surface in the radial direction of the rotational axis of the spool. The pillar portion extends from the inner circumferential surface of the bobbin trunk toward the rotational axis, and is disposed at a position that does not overlap with at least one through-hole as viewed from the radial direction. The pair of flanges extend from both ends of the bobbin trunk in a direction away from the rotational axis. The outer circumferential surface of the bobbin trunk has a tapered surface that is inclined in a direction approaching the rotational axis toward the pair of flanges.

In the spool for a dual-bearing reel according to the first aspect, since the outer circumferential surface of the bobbin trunk has a tapered surface that is inclined in a direction approaching the rotational axis toward the pair of flanges, it is possible to prevent the first layer of fishing line that is initially wound around the bobbin trunk from shifting when the second layer of fishing line is wound around the bobbin trunk. As a result, the static balance of the spool can be improved in a state in which the fishing line is wound around the spool, thereby improving the sensation of rotation during casting. In addition, since at least one through-hole and the pillar portion do not overlap as viewed from the radial direction, a knot to fix the fishing line to the spool can be easily placed in the through-hole. As a result, since the knot of the fishing line is prevented from protruding from the outer circumferential surface of the bobbin trunk, it is possible to wind the fishing line around the spool in accordance with the line guide. As a result, the static balance of the spool can be improved in a state in which the fishing line is wound around the spool, thereby improving the sensation of rotation during casting.

With regard to a second aspect of the present disclosure, in the spool for a dual-bearing reel according to the first aspect, the at least one through-hole of the bobbin trunk includes a first through-hole disposed at the center of the bobbin trunk in the axial direction of the rotational axis, and a second through-hole disposed adjacent to the first through-hole in the circumferential direction of the rotational axis. In the spool for a dual-bearing reel according to the second aspect, a fishing line can be passed through the first through-hole and the second through-hole to easily fix the fishing line to the spool. In addition, it is possible to start winding the fishing line around the spool from the center of the bobbin trunk in the axial direction of the rotational axis.

With regard to a third aspect of the present disclosure, in the spool for a dual-bearing reel according to the first aspect, the at least one through-hole and pillar portion of the bobbin trunk are arranged at positions offset from the center of the bobbin trunk in the axial direction of the rotational axis. In the spool for a dual-bearing reel according to the third aspect, it is possible to prevent the pillar thickness near the center of the bobbin trunk from increasing, thereby reducing inertia of the spool.

With regard to a fourth aspect of the present disclosure, in the spool for a dual-bearing reel according to the first aspect, the pair of flanges includes a first flange, and a second flange that is disposed so as to face the first flange in the axial direction of the rotational axis, the bobbin trunk further has an annular rib that protrudes from the inner circumferential surface of the bobbin trunk toward the rotational axis, the pillar portion is disposed between the first flange and the center of the bobbin trunk in the axial direction of the rotational axis, and the rib is disposed between the second flange and the center of the bobbin trunk in the axial direction of the rotational axis. In the spool for a dual-bearing reel according to the fourth aspect, the rigidity of the spool is increased.

With regard to a fifth aspect of the present disclosure, in the spool for a dual-bearing reel according to the fourth aspect, the at least one through-hole is disposed between the pillar portion and the first flange. In the spool for a dual-bearing reel according to the fifth aspect, it is possible to improve the static balance of the spool in a state in which the fishing line is wound around the spool, and to reduce inertia of the spool.

With regard to a sixth aspect of the present disclosure, in the spool for a dual-bearing reel according to any one of the first to the fifth aspects, the pillar portion overlaps with the tapered surface as viewed from the radial direction. In the spool for a dual-bearing reel according to the sixth aspect, it is possible to improve the static balance of the spool in a state in which the fishing line is wound around the spool.

With regard to a seventh aspect of the present disclosure, in the spool for a dual-bearing reel according to any one of the first to the sixth aspects, the outer circumferential surface of the bobbin trunk further has a flat surface that is disposed at the center of the bobbin trunk in the axial direction of the rotational axis and extends along the axial direction of the rotational axis, and the tapered surface is disposed adjacent to the flat surface. In the spool for a dual-bearing reel according to the seventh aspect, it is possible to improve the static balance of the spool in a state in which the fishing line is wound around the spool.

With regard to an eighth aspect of the present disclosure, in the spool for a dual-bearing reel according to any one of the first to the seventh aspects, the at least one through-hole has an elliptical shape that is longer in the circumferential direction of the rotational axis than in the axial direction of the rotational axis. In the spool for a dual-bearing reel according to the seventh aspect, it is possible to improve the static balance of the spool in a state in which the fishing line is wound around the spool.

With regard to the ninth aspect of the present disclosure, a dual-bearing reel comprises the spool according to any one of the first to the eighth aspects, and a level winding mechanism for evenly winding a fishing line around the spool. In the dual-bearing reel according to the ninth aspect, since the static balance of the spool is improved in a state in which the fishing line is wound around the spool, the sensation of rotation during casting is improved.

With regard to a tenth aspect of the present disclosure, in the dual-bearing reel according to the ninth aspect, the level winding mechanism has a line guide to guide the fishing line, the line guide has an opening through which the fishing line is passed, and the opening of the line guide has an upper edge that has a shape that tapers from bottom to top. In the dual-bearing reel according to the tenth aspect, since the fishing line is easily guided at one point on the upper edge when the fishing line is wound around the spool via the level winding mechanism, it is possible to wind the fishing line around the spool in accordance with the line guide. As a result, the static balance of the spool is improved in a state in which the fishing line is wound around the spool.

With regard to an eleventh aspect of the present disclosure, in the dual-bearing reel according to the tenth aspect, the opening further has a lower edge that is positioned below the upper edge and protrudes further forward than the upper edge. In the dual-bearing reel according to the eleventh aspect, it is possible, during casting, to prevent the fishing line from interfering with a level winding guard that is disposed in front of the level winding mechanism.

According to the present disclosure, it is possible to provide a spool and a dual-bearing reel that can improve the sensation of rotation during casting.

### BRIEF DESCRIPTION OF THE DRAWINGS

FIG. 1 is a perspective view of a dual-bearing reel.

FIG. 2 is a front view of the dual-bearing reel.

FIG. 3 is a rear view of the spool.

FIG. 4 is a cross-section diagram of the spool.

FIG. 5 is a partial cross-section diagram of the dual-bearing reel.

FIG. 6 is a front view of a line guide.

FIG. 7 is a cross-section diagram of a spool according to a modified example.

### DETAILED DESCRIPTION

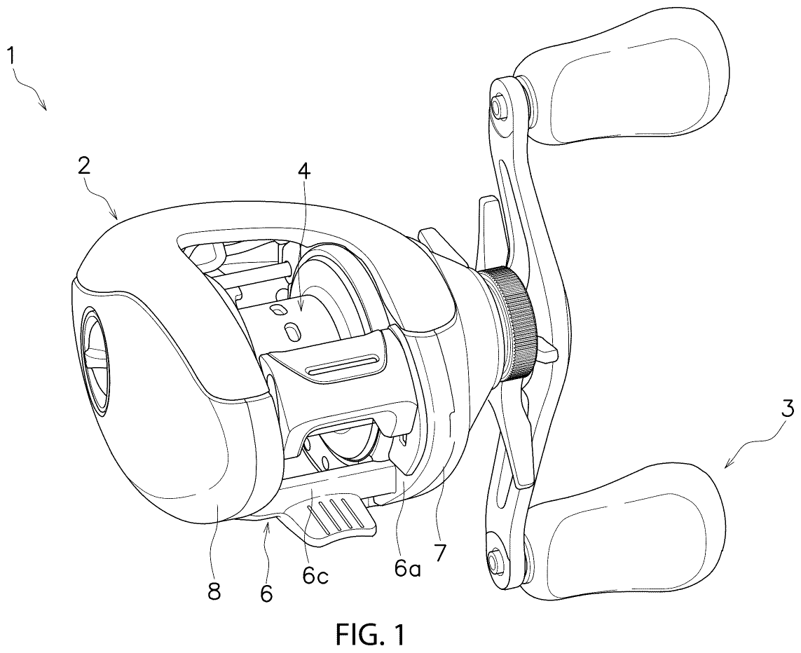

FIG. 1 is a perspective view of a dual bearing reel 1 comprising a spool according to one embodiment of the present disclosure.

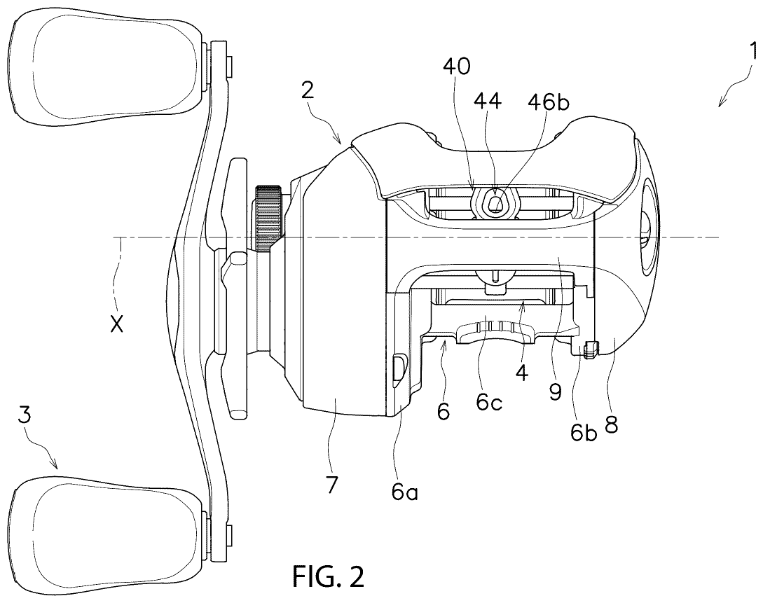

FIG. 2 is a front view of the dual-bearing reel 1.

As shown in FIGS. 1 and 2, the dual-bearing reel 1 comprises a reel body 2, a handle 3, and a spool 4. The dual bearing reel 1 further comprises various mechanisms (not shown), such as a rotation transmission mechanism for transmitting the rotation of the handle 3 to the spool 4, a clutch mechanism, a casting control mechanism, a spool braking mechanism, and a drag mechanism.

In the following description, the direction in which a fishing line is cast (unreeled) during fishing is referred to as the front, and the opposite direction is referred to as the rear. Additionally, left and right refer to left and right when the dual-bearing reel 1 is viewed from the rear. In addition, the direction in which the rotational axis X of the spool 4 extends is referred to as the axial direction, the direction perpendicular to the rotational axis X is referred to as the radial direction, and the direction around the rotational axis X is referred to as the circumferential direction.

The reel body 2 has a frame 6, a right side cover 7 that covers the right side of the frame 6, and a left side cover 8 that covers the left side of the frame 6. The frame 6 has a first side plate 6a, a second side plate 6b disposed spaced apart from the first side plate 6a in the axial direction, and a plurality of connectors 6c that connect the first side plate 6a and the second side plate 6b.

The handle 3 is attached to the side of the reel body 2 so as to be rotatable. In the present embodiment, the handle 3 is attached to the right side of the reel body 2.

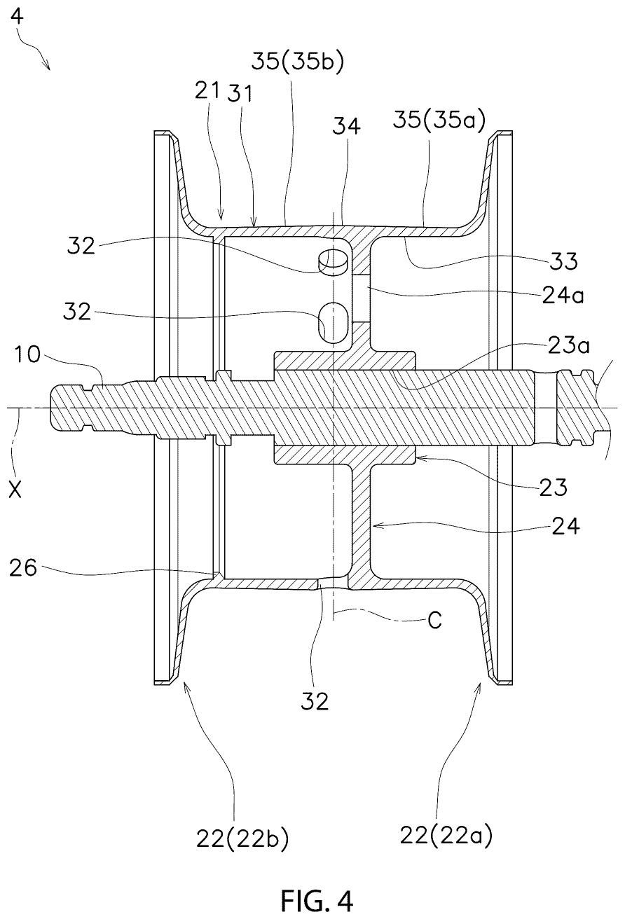

The spool 4 is supported so as to be rotatable by the reel body 2 between the first side plate 6a and the second side plate 6b. The spool 4 is fixed to a spool shaft 10 (see FIG. 4) which is supported by the reel body 2 so as to be rotatable, and is supported so as to be rotatable by the reel body 2 via the spool shaft 10. In the present embodiment, the rotational axis X of the spool 4 coincides with the axis of the spool shaft 10.

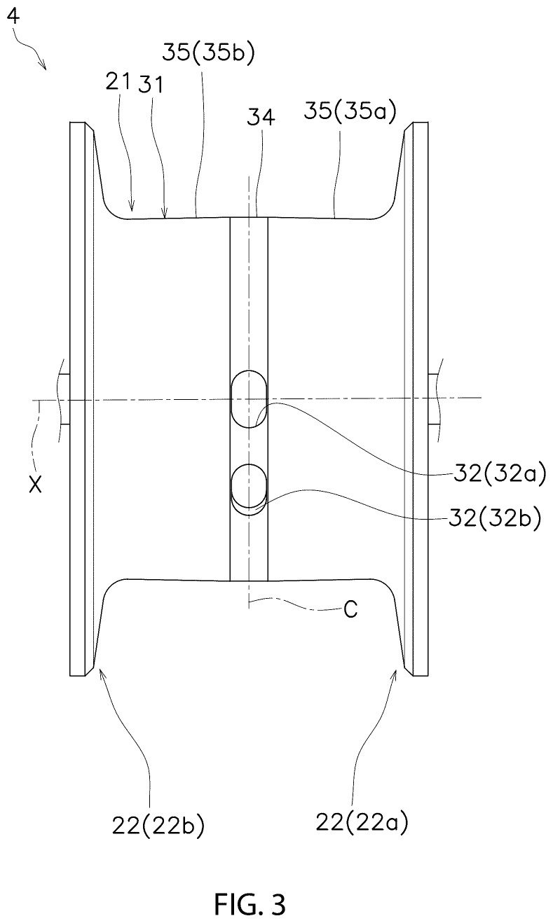

FIG. 3 is a rear view of the spool 4. FIG. 4 is a cross-section diagram of the spool 4. As shown in FIGS. 2 and 3, the spool 4 comprises a bobbin trunk 21, a pair of flanges 22, a shaft mounting portion 23, a pillar portion 24, and a rib 26.

The bobbin trunk 21 has a substantially cylindrical shape. The bobbin trunk 21 extends in the axial direction. The bobbin trunk 21 has an outer circumferential surface 31 around which the fishing line is wound, and at least one through-hole 32. The outer circumferential surface 31 has a flat surface 34 and a tapered surface 35. The flat surface 34 is disposed at the center C of the bobbin trunk 21 in the axial direction. The flat surface 34 extends along the axial direction.

The tapered surface 35 is inclined in a direction approaching the rotational axis X toward the pair of flanges 22. The tapered surface 35 is inclined such that the distance to the rotational axis X gradually decreases as the tapered surface 35 approaches the center C of the bobbin trunk 21 in the axial direction. The taper angle of the tapered surface 35 with respect to the rotational axis X is preferably within the range of 0.1° to 3°, and more preferably within the range of 1° to 2°.

The tapered surface 35 is disposed adjacent to the flat surface 34. The tapered surface 35 has a first tapered surface 35a and a second tapered surface 35b. The first tapered surface 35a is disposed on the right side of the center C of the bobbin trunk 21 in the axial direction. The first tapered surface 35a is connected to the right end of the flat surface 34. The second tapered surface 35b is disposed on the left side of the center C of the bobbin trunk 21 in the axial direction. The second tapered surface 35b is connected to the left end of the flat surface 34. The second tapered surface 35b has a shape that is symmetrical to the first tapered surface 35a.

At least one through-hole 32 is disposed on the outer circumferential surface 31 and penetrates, in the radial direction, the outer circumferential surface 31 and an inner circumferential surface 33 of the bobbin trunk 21. The at least one through-hole 32 is disposed at the center C of the bobbin trunk 21 in the axial direction. The at least one through-hole 32 overlaps with the flat surface 34 as viewed from the radial direction. The at least one through-hole 32 has an elliptical shape that is longer in the circumferential direction than in the axial direction.

In the present embodiment, the at least one through-hole 32 includes a plurality of through-holes, including a first through-hole 32a and a second through-hole 32b. In the present embodiment, six through-holes 32 are formed in the bobbin trunk 21. The first through-hole 32a and the second through-hole 32b are arranged adjacent to each other in the circumferential direction. The through-holes 32 are preferably arranged at equal intervals in the circumferential direction.

The pair of flanges 22 are substantially disk-shaped. The pair of flanges 22 extend from the two ends of the bobbin trunk 21 in a direction away from the rotational axis X. The pair of flanges 22 extend radially outward from the two ends of the bobbin trunk 21. The pair of flanges 22 are inclined so as to widen axially outward while extending in the radially outward direction.

The pair of flanges 22 includes a first flange 22a and a second flange 22b. In the present embodiment, the first flange 22a is disposed at a position closer to the handle 3 than the second flange 22b in the axial direction. The first flange 22a extends radially outward from the right end of the first tapered surface 35a. The second flange 22b is disposed facing the first flange 22a in the axial direction. The second flange 22b is farther away from the handle 3 than the first flange 22a in the axial direction. The second flange 22b extends radially outward from the left end of the second tapered surface 35b.

The shaft mounting portion 23 is disposed on the inner peripheral side of the bobbin trunk 21. The shaft mounting portion 23 is formed in a tubular shape. The shaft mounting portion 23 has a through-hole 23a extending in the axial direction. The spool shaft 10 is press-fitted and fixed in the through-hole 23a.

The pillar portion 24 connects the bobbin trunk 21 and the shaft mounting portion 23. The pillar portion 24 is substantially disk-shaped. The pillar portion 24 extends in the radial direction. The pillar portion 24 extends from the inner circumferential surface 33 of the bobbin trunk 21 toward the rotational axis X. The pillar portion 24 extends from the outer circumferential surface of the shaft mounting portion 23 toward the inner circumferential surface 33 of the bobbin trunk 21. As shown in FIG. 4, the pillar portion 24 has a plurality of through-holes 24a extending in the axial direction. The plurality of through-holes 24a are arranged spaced apart from each other in the circumferential direction.

The pillar portion 24 is disposed at a position that does not overlap with at least one of the through-holes 32 as viewed from the radial direction. The pillar portion 24 is disposed at a position offset from the center C of the bobbin trunk 21 in the axial direction. The pillar portion 24 is disposed at a position offset toward the handle 3 side with respect to the center C of the bobbin trunk 21 in the axial direction. The pillar portion 24 is disposed between the first flange 22a and the center C of the bobbin trunk 21 in the axial direction. The pillar portion 24 is disposed at a position closer to the first flange 22a than the second flange 22b in the axial direction. The pillar portion 24 overlaps with the first tapered surface 35a of the tapered surface 35 as viewed from the radial direction.

The rib 26 is an annular rib protruding from the inner circumferential surface 33 of the bobbin trunk 21 toward the rotational axis X. The rib 26 is disposed between the second flange 22b and the center C of the bobbin trunk 21 in the axial direction. The rib 26 overlaps with the second tapered surface 35b of the tapered surface 35 as viewed from the radial direction. The rib 26 is disposed on the inner circumferential surface 33 of the bobbin trunk 21 that is proximate to the second flange 22b. The rib 26 does not overlap with the shaft mounting portion 23 as viewed from the radial direction.

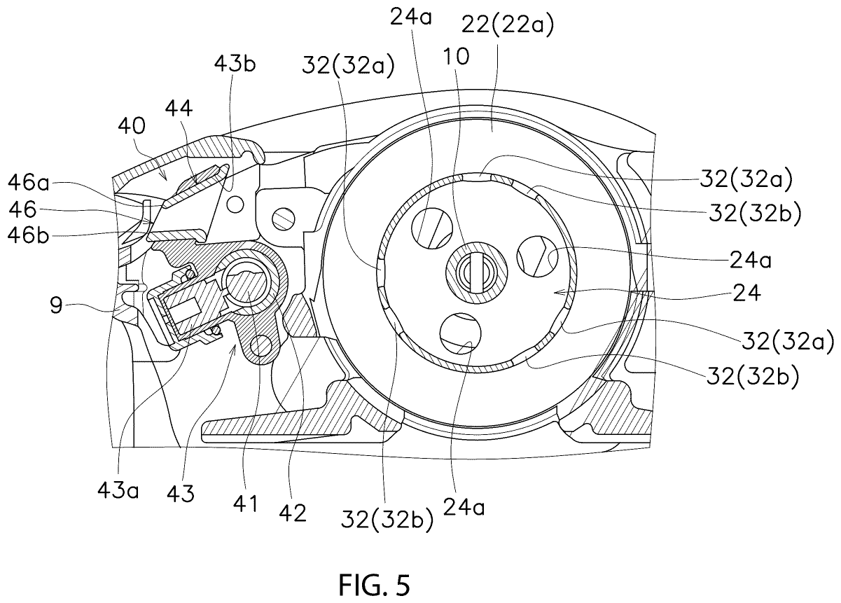

As shown in FIGS. 2 and 5, the dual-bearing reel 1 comprises a level winding mechanism 40 that evenly winds the fishing line around the spool 4. The level winding mechanism 40 comprises a worm shaft 41, a guide member 42, a sliding member 43, and a line guide 44. The worm shaft 41 extends in the axial direction. The worm shaft 41 is supported by the reel body 2 so as to be rotatable. A spiral groove is formed on the outer circumferential surface of the worm shaft 41. The guide member 42 is a member to guide the sliding member 43. The guide member 42 is formed in a cylindrical shape. The guide member 42 is disposed on the radially outer side of the worm shaft 41. The sliding member 43 has an engagement member 43a that meshes with the spiral groove of the worm shaft 41. When the worm shaft 41 rotates in accordance with the rotation of the handle 3, the sliding member 43 moves back and forth in the axial direction along the guide member 42.

The line guide 44 is disposed on the sliding member 43. The line guide 44 is fixed to the sliding member 43 so as to be able to move integrally with the sliding member 43. The line guide 44 is fixed to a fixing hole 43b of the sliding member 43. The line guide 44 can be integrated with the sliding member 43. The line guide 44 extends in the front-rear direction. The upper portion of the line guide 44 is inclined upward toward the rear. The lower portion of the line guide 44 extends substantially in the horizontal direction.

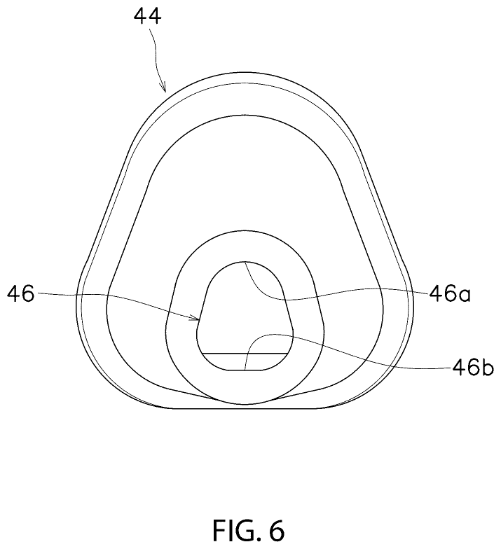

As shown in FIGS. 5 and 6, the line guide 44 has an opening 46 through which the fishing line is passed. The opening 46 is opened to the front. The opening 46 is formed so as to extend through the line guide 44 in the front-rear direction.

The opening 46 has an upper edge 46a and a lower edge 46b. The upper edge 46a has a shape that tapers from the bottom to the top. The upper edge 46a is formed such that the axial dimension thereof gradually decreases from the bottom to the top. The upper end of the upper edge 46a is formed in an arc shape. The upper edge 46a is configured so as to come in point contact with the fishing line when the fishing line is wound around the spool 4. When the fishing line is wound around the spool 4, the fishing line is guided at a point on the upper edge 46a. The lower edge 46b is disposed below the upper edge 46a. The lower edge 46b protrudes further forward than the upper edge 46a.

As shown in FIG. 2, the lower edge 46b of the opening 46 is disposed above a level winding guard 9 disposed in the reel body 2. The level winding guard 9 is disposed in front of the sliding member 43. The axial distance from the lower edge 46b of the opening 46 to the level winding guard is smaller than the axial distance from the upper edge 46a of the opening 46 to the level winding guard. That is, in the axial direction, the lower edge 46b of the opening 46 is disposed at a position closer to the level winding guard than the upper edge 46a of the opening 46.

In the dual-bearing reel 1 described above, since the outer circumferential surface 31 of the bobbin trunk 21 of the spool 4 has a tapered surface 35 that is inclined in a direction approaching the rotational axis X toward the pair of flanges 22, it is possible to prevent the first layer of fishing line that is initially wound around the bobbin trunk 21 from shifting when the second layer of fishing line is wound around the bobbin trunk 21. As a result, the static balance of the spool 4 is improved in a state in which the fishing line is wound around the spool, thereby improving the sensation of rotation during casting.

In addition, since at least one of the through-holes 32 and the pillar portion 24 do not overlap as viewed from the radial direction, a knot for fixing the fishing line to the spool 4 can be easily placed in the at least one through-hole 32. As a result, since the knot of the fishing line does not protrude from the outer circumferential surface 31 of the bobbin trunk 21, it is possible to wind the fishing line around the spool 4 in accordance with the line guide. As a result, the static balance of the spool 4 can be improved in a state in which the fishing line is wound around the spool 4, thereby improving the sensation of rotation during casting.

### OTHER EMBODIMENTS

One embodiment of the present disclosure was described above, but the present disclosure is not limited to the above-described embodiment, and various modifications can be made without departing from the scope of the disclosure.

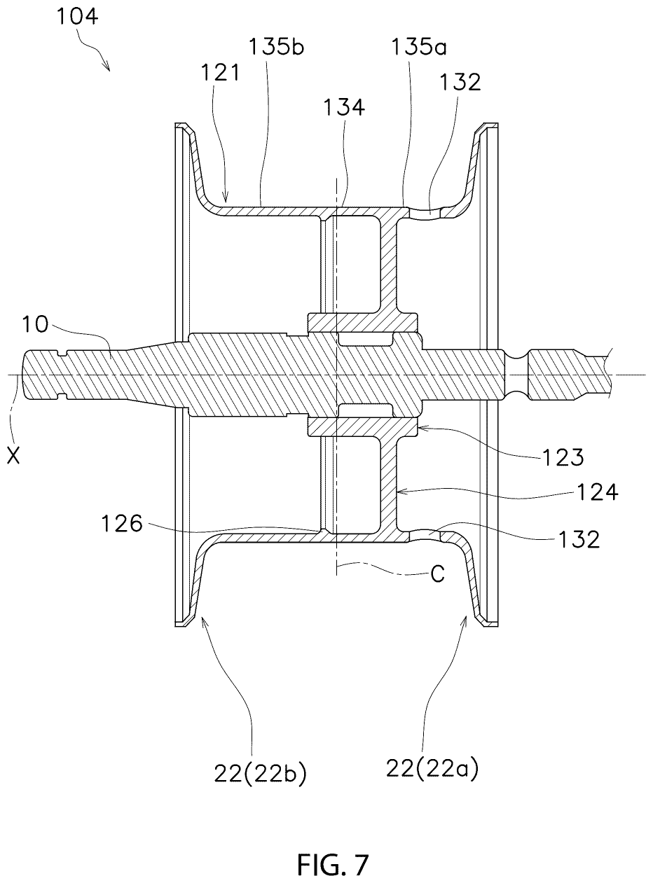

FIG. 7 is a cross-section diagram of a spool 104 according to another embodiment of the present disclosure. With regard to the spool 104, configurations that are different from the above embodiment will be described, while descriptions of configurations that are essentially the same as the above embodiment will be omitted.

At least one through-hole 132 of a bobbin trunk 121 of the spool 104 is disposed at a position offset from the center C of the bobbin trunk 121 in the axial direction. The at least one through-hole 132 is disposed between a pillar portion 124 and the first flange 22a. The pillar portion 124 is disposed at a position that is, compared to the above embodiment, further offset toward the handle 3 side with respect to the center C of the bobbin trunk 121 in the axial direction. In the axial direction, the distance from the pillar portion 124 to a flat surface 134 is larger than the distance from a rib 126 to the flat surface 134.

The rib 126 overlaps with the flat surface 134 as viewed from the radial direction. The rib 126 overlaps with a shaft mounting portion 123 as viewed from the radial direction. The axial distance from the rib 126 to the pillar portion 124 is smaller than the axial dimensions of a first tapered surface 135a and a second tapered surface 135b. The pillar thickness of the flat surface 134 is thinner than the pillar thickness of the flat surface 34 according to the above embodiment. The pillar thickness of the flat surface 134 is thinner than the pillar thickness of at least a portion of the first tapered surface 135a.

In a dual-bearing reel in which the handle 3 is disposed on the left side of the reel body 2, the configurations of the spools 4 and 104 can be employed.

In the present embodiment, the flange portion disposed at the left end of the bobbin trunk 21 can be the first flange 22a, and the flange portion disposed at the right end of the bobbin trunk 21 can be the second flange 22b.

What is claimed is:

1. A spool for a dual-bearing reel, comprising:
a bobbin trunk having an outer circumferential surface around which a fishing line is capable of being wound, and a through-hole extending through the outer circumferential surface in a radial direction of a rotational axis of the spool;
a pillar portion extending from an inner circumferential surface of the bobbin trunk toward the rotational axis, and being disposed at a position that does not overlap with the through-hole as viewed from the radial direction; and
first and second flanges extending from first and second ends of the bobbin trunk, respectively, in a direction away from the rotational axis,
the outer circumferential surface of the bobbin trunk having a tapered surface inclined in a direction approaching the rotational axis toward the first and second flanges.

2. The spool for a dual-bearing reel according to claim 1, wherein
the through-hole of the bobbin trunk is a first through-hole disposed at a center of the bobbin trunk in an axial direction of the rotational axis, and the bobbin trunk includes a second through-hole disposed adjacent to the first through-hole in a circumferential direction of the rotational axis.

3. The spool for a dual-bearing reel according to claim 1, wherein
the through-hole and the pillar portion of the bobbin trunk are disposed at positions offset from a center of the bobbin trunk in an axial direction of the rotational axis.

4. The spool for a dual-bearing reel according to claim 1, wherein
the first flange faces the second flange in an axial direction of the rotational axis, and
the bobbin trunk further comprises an annular rib protruding from an inner circumferential surface of the bobbin trunk toward the rotational axis,
the pillar portion is disposed between the first flange and the center of the bobbin trunk in the axial direction of the rotational axis, and
the rib is disposed between the second flange and the center of the bobbin trunk in the axial direction of the rotational axis.

5. The spool for a dual-bearing reel according to claim 4, wherein
the through-hole is disposed between the pillar portion and the first flange.

6. The spool for a dual-bearing reel according to claim 1, wherein
the pillar portion overlaps with the tapered surface as viewed from the radial direction.

7. The spool for a dual-bearing reel according to claim 1, wherein
the outer circumferential surface of the bobbin trunk further has a flat surface disposed at a center of the bobbin trunk in an axial direction of the rotational axis and extending along the axial direction of the rotational axis, and
the tapered surface is disposed adjacent to the flat surface.

8. The spool for a dual-bearing reel according to claim 1, wherein
the through-hole has an elliptical shape that is longer in a circumferential direction of the rotational axis than in an axial direction of the rotational axis.

9. A dual-bearing reel, comprising
the spool according to claim 1, and
a level winding mechanism configured to evenly wind a fishing line around the spool.

10. The dual-bearing reel according to claim 9, wherein
the level winding mechanism has a line guide configured to guide the fishing line,
the line guide has an opening through which the fishing line is capable of being passed, and
the opening of the line guide includes an upper edge having a shape that is tapered from a bottom to a top.

11. The dual-bearing reel according to claim 10, wherein
the opening further has a lower edge positioned below the upper edge and protruding further forward than the upper edge.
